(19) United States
(12) Patent Application Publication
(10) Pub. No.: US 2017/0223654 A1
(43) Pub. Date: Aug. 3, 2017

(54) REGISTRATION MANAGEMENT OF WIRELESS COMMUNICATION DEVICES WITH A COMMUNICATION SYSTEM

(71) Applicant: MOTOROLA SOLUTIONS, INC., Schaumburg, IL (US)

(72) Inventors: Kangkai ZHAO, Chengdu, Sichuan (CN); Wu YANG, Chengdu, Sichuan (CN); Yu ZHOU, Chengdu, Sichuan (CN)

(21) Appl. No.: 15/119,998

(22) PCT Filed: Sep. 16, 2015
(86) PCT No.: PCT/CN2015/089754

§ 371 Date: Aug. 18, 2016

(51) Int. Cl. H04W 60/00; H04W 76/02; H04W 28/02; H04W 60/06

(52) U.S. Cl. CPC H04W 60/005; H04W 60/06; H04W 76/025; H04W 28/0231; H04W 4/008

(57) ABSTRACT

A method and apparatus for managing registration of a plurality of wireless communication devices to a plurality of different networks with a controller. The controller controls registration and registration priority to each of the plurality of wireless communication devices. Based on the registration priority, the registration limits of each network, and an amount of wireless communication device registrations associated with a wireless communication device user, the controller controls registration of each of the wireless communication devices across the plurality of networks. Controlling registration includes denying registration to a wireless communication device user that has a preexisting network connection, deregistering a wireless communication device that has more than one network connection, and registering/deregistering wireless communication devices based on the registration priority of each wireless communication device.

### BACKGROUND OF THE INVENTION

Wireless networks typically provide access to wireless communication devices based on network access requests from wireless communication devices and network capacity. The network assigns registrations to wireless communication devices as each wireless communication device requests access. When the amount of registrations to the network reaches a registration limit of that network, additional wireless communication devices requesting access are denied registration to that network. When users of the wireless communication devices gather in large numbers, network access may be restricted due to the large number of registration requests.

This is particularly problematic, when an emergency or other public safety incident occurs. Large numbers of first responders (i.e. people designated and trained to respond to an emergency) may respond to the scene of the incident and request access via their wireless communication devices to a proximate network. In some situations, many wireless communication devices carried by the first responders may request access to a network at approximately the same time. This may include combinations of first responders from different public service departments such as police officers, fire fighters, medical personnel, and others. Each first responder may carry multiple wireless communication devices. These wireless communication devices may be designed to operate in accordance with numerous different protocols and network technologies. When numerous simultaneous or near simultaneous access requests are made, network congestion may occur and network access may be denied. Accordingly, there is a need for a network management system to control and coordinate wireless communication device registrations, and, more particularly, wireless communication device registrations of wireless communication devices with a communication system that has a plurality of networks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a network controller in accordance with some embodiments.

FIG. 2 is a block diagram of a network including the network controller of FIG. 1 in accordance with some embodiments.

FIG. 3 is a table of active wireless communication device registrations, associated users, and associated networks in accordance with some embodiments.

FIG. 4 is a flowchart of a method of operating the network of FIG. 2 in accordance with some embodiments.

FIG. 5 is a flowchart of a method of operating the network of FIG. 2 in accordance with some other embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One embodiment provides a method of managing registrations of a plurality of wireless communication devices with a communication system that includes a plurality of networks, at least one of the plurality of networks having a different communication protocol than another one of the plurality of networks. The method includes assigning a registration limit to each of the plurality of networks. The registration limits indicating a maximum number of wireless communication devices supported by each of the plurality of networks. The method also includes assigning a registration priority to each of the plurality of wireless communication devices; and controlling, via a controller, registration of each of the plurality of wireless communication devices to the plurality of networks. Controlling the registration is based on the registration limits, the registration priorities, and a quantity of wireless communication device registrations assigned to a wireless communication device user.

Another embodiment provides a communication system for managing registration of a plurality of wireless communication devices. The communication system includes a plurality of networks. At least one of the plurality of networks has a different communication protocol than another one of the plurality of networks. The communication system has a controller that is configured to assign a registration limit to each of the plurality of networks and assign a registration priority to each of the plurality of wireless communication devices. Further, the controller controls registration of each of the plurality of wireless communication devices to the plurality of networks based on the registration limits, the registration priorities, and a quantity of wireless communication device registrations assigned to a wireless communication device user.

First responders often use one or more wireless communication devices that operate on a plurality of different networks. For example, first responders may use a land mobile radio (e.g., two-way radio) network, a cellular network (e.g., Long-Term Evolution (LTE), and a local area network (e.g., wireless fidelity (Wi-Fi)). In addition, the wireless communication devices may be able to connect using short-range communication (e.g., Bluetooth) protocols. Some wireless communication devices are configured to operate on more than one of these networks. In such cases, the wireless communication device may request access to multiple networks. Similarly, when a first responder carries multiple wireless communication devices, that user may be able to connect to one or more of the networks using the multiple wireless communication devices. When each first responder has multiple network connections, each of the networks may reach a registration limit sooner than if each first responder was limited to a single network connection. Accordingly, the network management system for wireless communication device registration seeks to maximize network access by limiting each first responder to a single network connection when the networks reach their respective registration limits.

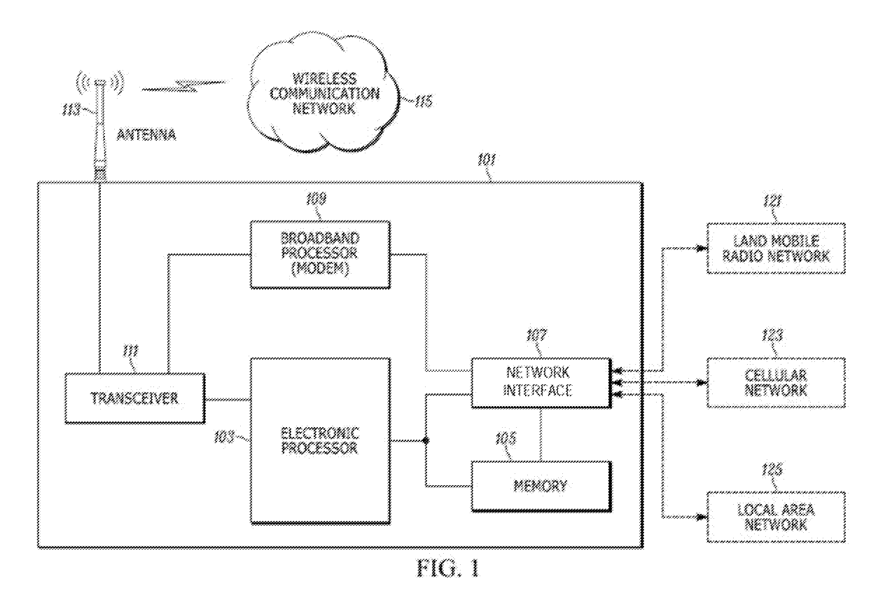

FIG. 1 is a block diagram of a network controller 101 according to one exemplary embodiment. The network controller 101 includes an electronic processor 103 (e.g., a microprocessor or another suitable programmable device), a memory 105 (e.g., a non-transitory, machine-readable storage medium), an network interface 107, a baseband processor 109 (e.g., a network modem), a transceiver 111, and an antenna 113. In some embodiments, the network controller 101 is communicatively coupled via a wired connection to a land mobile radio (LMR) network 121, a cellular (e.g., a Long-Term Evolution (LTE)) network 123, and/or a local area (e.g., Wi-Fi) network 125. In other embodiments, the network controller 101 is communicatively coupled via a wireless connection to one or more of the land mobile radio network 121, the cellular network 123, and the local area network 125. The network interface 107 operates to receive network input, to provide network output, or a combination of both.

The baseband processor 109 is configured to encode and decode digital data sent and received by the transceiver 111 to and from the wireless communication network 115 via the antenna 113. The wireless communication network 115 may include one or more land mobile radio networks, cellular networks (e.g., Long-Term Evolution (LTE), Time Division Multiple Access (TDMA), and Code Division Multiple Access (CDMA)), and other local and wide area networks (e.g., Worldwide Interoperability for Microwave Access (WiMax)). The wireless communication network 115 may also have one or more connections to a public switched telephone network (PSTN), and/or the Internet, and/or an equivalent.

The electronic processor 103, the memory 105, the network interface 107, the baseband processor 109, and the transceiver 111, as well as other various modules and components, are coupled by one or more control or data buses to enable communication between the various modules and components. The memory 105 may include a program storage area (e.g., read only memory (ROM)) and a data storage area (e.g., random access memory (RAM), and other non-transitory, machine-readable medium). The electronic processor 103 is coupled to the memory 105 and executes machine-readable instructions (“software”) stored in the memory 105. For example, instructions stored in the memory 105 that when run by the electronic processor 103 may perform the methods described herein. The software may also include one or more applications, operating systems, graphical user interfaces, program data, filters, rules, one or more program modules, and/or other executable instructions.

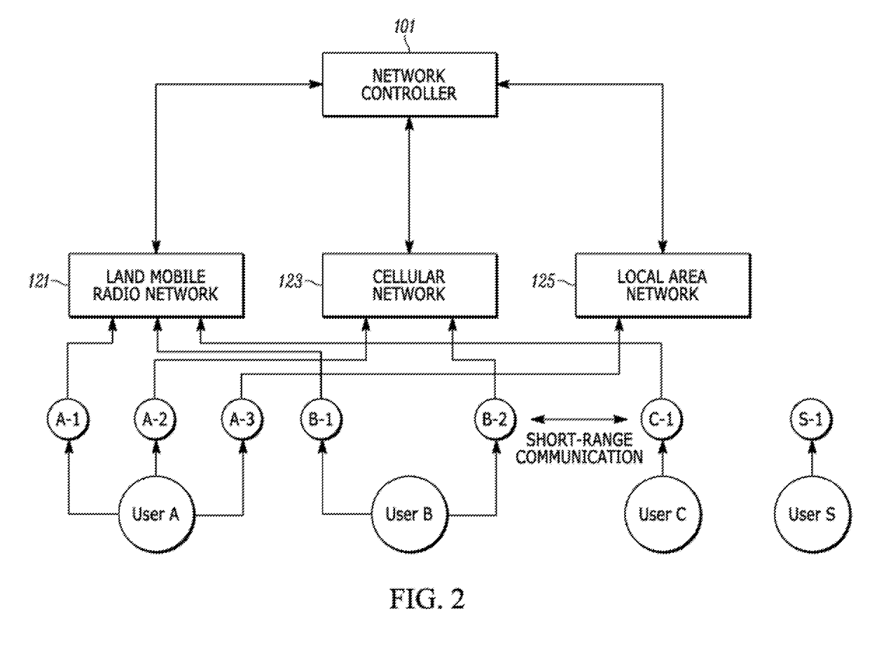

FIG. 2 is a block diagram of an exemplary network configuration. The network controller 101 is communicatively coupled to a plurality of networks, where at least some of the plurality of networks operate in accordance with communication protocols that are different from the communication protocols of the other networks. Although illustrated as different types of networks, the plurality of networks may include two of more networks using the same type of communication protocol. The plurality of networks include the land mobile radio network 121, the cellular network 123, and the local area network 125. The network controller 101 receives information from the land mobile radio network 121, the cellular network 123, and the local area network 125 regarding, among other things, current wireless communication device registrations and registration limits. The network configuration includes a plurality of wireless communication devices (A-1, A-2, A-3, B-1, B-2, C-1, and S-1) associated with a plurality of wireless communication device users (User A, User B, User C, and User S). In the example illustrated, the wireless communication devices A-1, B-1, and C-1 are registered with the land mobile radio network 121. The wireless communication devices A-1, B-1, and C-1 are tracked by the network controller 101 via at least the land mobile radio network 121. Also, in the example illustrated, the cellular network 123 associates wireless communication devices A-2 and B-2 with wireless communication device users, User A and User B, for example, by name or another user identifier. In the example illustrated, the wireless communication device A-3 is registered with the local area network 125. In addition, the wireless communication device B-2 is communicatively coupled with the wireless communication device C-1 via short-range communication (e.g., Bluetooth).

In some embodiments, the network controller 101 coordinates and controls registrations of wireless communication devices with the land mobile radio network 121, the cellular network 123, and the local area network 125. In particular, when a registration request is received by one of the land mobile radio network 121, the cellular network 123, and the local area network 125, the network that receives the request sends a message to the network controller 101 indicating that a request has been made. The message may include information about the wireless communication device and the status of the respective network. The network controller 101 sends a message in response indicating whether the wireless communication device that requested registration should be registered. In these embodiments, the network controller 101 may communicate with the land mobile radio network 121, the cellular network 123, and the local area network 125 to obtain information regarding currently registered wireless communication devices.

In other embodiments, each of the land mobile radio network 121, the cellular network 123, and the local area network 125 may handle requests of registration from each of the wireless communication devices A-1, A-2, A-3, B-1, B-2, C-1, and S-1 independently of the network controller 101 and each other. In these cases, registration happens with the respective network without initiating communication with the network controller 101. However, once the respective network reaches its registration limit, the respective network sends a message to the network controller 101 including information about the status of the network and current wireless mobile device registrations to request instructions from the network controller 101.

For example, when the wireless communication device S-1, associated with User S, requests access to the land mobile radio network 121, the cellular network 123, or the local area network 125, the respective network will register the wireless communication device S-1 provided there is sufficient space for registration on that network. In particular, when the wireless communication device S-1 requests registration on the local area network 125, the local area network 125 registers the wireless communication device S-1 independently of the network controller 101 provided that the local area network 125 is not at its registration limit. In such embodiments, when at least one of the networks reaches its registration limit, the network controller 101 controls network access by one or more of the methods described below.

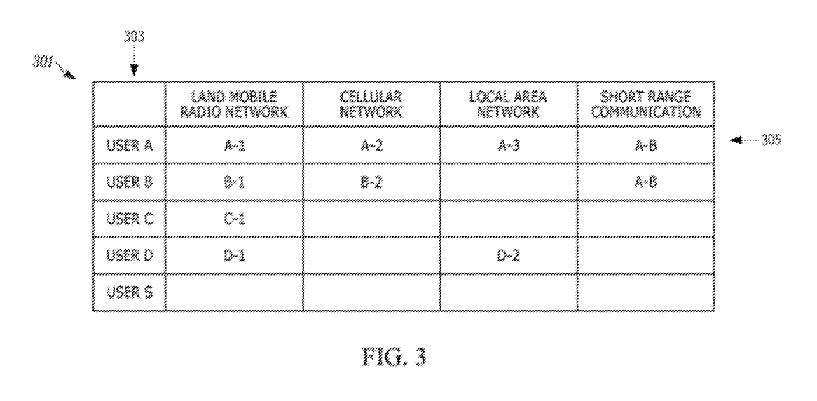

Table 301, illustrated in FIG. 3, summarizes wireless communication device registrations and associated wireless communication device users in accordance with one embodiment. The table 301 is created and stored in the memory 105 of the network controller 101. The network controller 101 updates the table 301 as wireless communication devices register and de-register from the land mobile radio network 121, the cellular network 123, or the local area network 125. The network controller 101 also updates the table 101 to reflect which wireless communication devices are associated with which users. Various techniques may be used to match wireless communication devices with users, such as, for example, requiring a user to provide a unique user identification with the wireless communication device.

In this way, the network controller 101 may track registrations of the plurality of wireless communication devices and the associated users across the plurality of networks using the table 301. In the example illustrated, the table 301 includes a list of users 303 (User A, User B, User C, User D) and a list of wireless communication device registrations 305. For example, User A has three wireless communication device registrations (A-1, A-2, and A-3) and User B has two wireless communication device registrations (B-1 and B-2). It should be noted that each wireless communication device may have one or more wireless communication device registrations with each registration corresponding to a different network. Alternatively, multiple wireless communication device registrations may be assigned to multiple wireless communication devices and associated users. For example, User A may have three wireless communication devices (A-1, A-2, and A-3) or may have a single wireless communication device with three wireless communication device registrations (A-1, A-2, and A-3). In addition, various combinations of wireless communication device registrations are also possible such as a first wireless communication device having wireless communication device registrations A-1 and A-2 and a second wireless communication device having wireless communication device registration A-3. The table 301 also includes a list of linked users 307. The list of linked users 307 tracks which users are associated with wireless communication devices that are communicating via short-range communication (e.g., Bluetooth). In this example, User A and User B have one or more wireless communication devices that are linked via short range communication.

Through use of the table 301, the network controller 101 tracks which wireless communication devices are associated with which users, which wireless communication devices are registered with which networks, and which wireless communication devices are in direct communication with each other. The table 301 is but one example of a method of tracking the above features in the network controller 101. The network controller 101 may use other methods for tracking wireless communication device registrations and wireless communication device users.

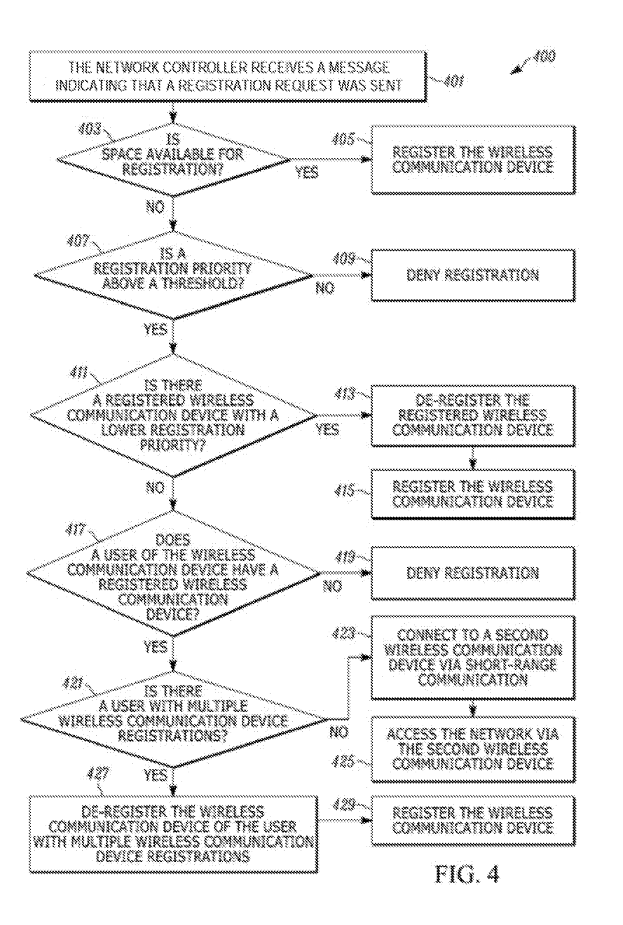

FIG. 4 is a flowchart of a method 400 of controlling the plurality of networks via the network controller 101 according to one embodiment. When a wireless communication device S-1 attempts to register on one of the networks (e.g., the cellular network 123), the network controller 101 receives a message from the network indicating that the registration request was sent (block 401). Information is exchanged between the network and the network controller 101 to facilitate the registration request. The network determines if space is available for registration to the network (i.e., when the network is not at its registration limit) (block 403). When space is available for registration, the network registers the wireless communication device S-1 (block 405). The network may register the wireless communication device S-1 regardless of its registration priority. When space is not available for registration, the network sends a message to the network controller 101, and the network controller 101 determines if the registration priority of the wireless communication device S-1 is above a threshold (e.g., unauthorized) (block 407). When the registration priority is not above a threshold, the network controller 101 sends a message to the network to deny the registration of the wireless communication device S-1 (block 409).

Conversely, when the registration priority of the wireless communication device S-1 is above the threshold, the network controller 101 determines if there is a wireless communication device with a lower registration priority already registered to the network (block 411). If there is a wireless communication device with a lower registration priority, the network controller 101 sends a message to the network to de-register the registered wireless communication device with the lower registration priority (block 413). The network then registers the wireless communication device S-1 to the network (block 415). If there is no registered wireless communication device with a lower registration priority than the wireless communication device S-1, the network controller 101 determines whether User S, associated with the wireless communication device S-1, has at least one wireless communication device registration on any one of the plurality of networks (block 417). When the User S has at least one other wireless communication device registration on any one of the plurality of networks (e.g., the land mobile radio network 121), the network controller 101 sends a message to the network to deny registration of the wireless communication device S-1 (block 419).

When User S is not associated with at least one other wireless communication device registration, the network controller 101 determines whether there is another user associated with multiple wireless communication device registrations on one or more wireless communication devices (block 421). When there is not another user associated with more than one wireless communication device registration, the network controller 101 instructs the wireless communication device S-1, via the network, to connect to the network via a second wireless communication device that is registered to the network (block 423). In such a case, when available, the wireless communication device S-1 connects with the second wireless communication device via short-range communication (e.g., Bluetooth). The wireless communication device then accesses the network via the second wireless communication device (block 425). Conversely, when there is another user associated with multiple wireless communication device registrations and when one of the multiple wireless communication device registrations is registered to the network that S-1 is attempting to access, the network controller 101 sends a message to the network to de-register the wireless communication device from the network that S-1 is attempting to access (block 427). When the multiple wireless communication device registrations are registered on different networks of the plurality of networks, the network controller 101 will attempt to identify another user with multiple wireless communication device registrations that has a wireless communication device registration on the desired network. After the wireless communication device is de-registered, the network registers the wireless communication device S-1 to the network (block 427).

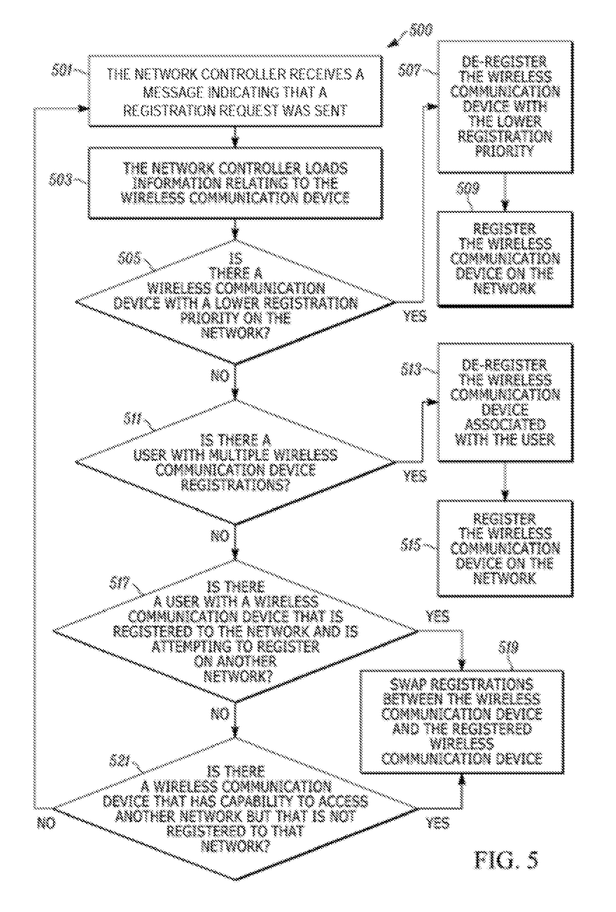

FIG. 5 is a flowchart of a method 500 of controlling the plurality of networks via the network controller 101. When the wireless communication device (e.g., S-1) attempts to register on one of the networks (e.g., the local area network 125), the wireless communication device S-1 sends a registration request to the respective network (block 501). In this example, the wireless communication device S-1 may also be registered on at least one other network (e.g., land mobile radio network 121). Also in this example, S-1 is attempting to register on the local area network 125 and S-1 is currently registered on the land mobile radio network 121. However, it should be understood that this is an example and that any one of the plurality of networks may be substituted for these two networks when performing the method 500.

When the wireless communication device S-1 attempts to register on the local area network 125, the network controller 101 loads information relating to the wireless communication device S-1 to the table 301 (block 503). The network controller 101 determines if there are any wireless communication devices registered to the local area network 125 with a lower registration priority than the wireless communication device S-1 (block 505). If so, the network controller 101 sends a message to the local area network 125 to de-register one of the wireless communication devices with lower registration priority (block 507). Then, the local area network 125 registers the wireless communication device S-1 (block 509). Alternatively, when there are no wireless communication devices with a lower registration priority, then the network controller 101 determines if there is a wireless communication device user with multiple wireless communication device registrations (block 511). If so, the network controller 101 sends a message to the local area network 125 to de-register the wireless communication device associated with the user with multiple wireless communication device registrations (block 513). Then, the local area network 125 registers the wireless communication device S-1 (block 515).

Alternatively, if there is not a wireless communication device user with multiple wireless communication device registrations, then the network controller 101 determines if there is a wireless communication device user that is associated with a wireless communication device that is registered to the local area network 125 and if the wireless communication device user is associated with a wireless communication device that is attempting to register to the land mobile radio network 121 (block 517). If so, the network controller 101 sends a message to the land mobile network 121 to de-registers the wireless communication device S-1, sends a message to the land mobile network 121 to register the wireless communication device that is attempting to register, sends a message to the local area network 125 to de-register the same wireless communication device, and sends a message to the local area network 125 to register the wireless communication device S-1 (block 519). If there is not a wireless communication device user that has a wireless communication device that is registered to the local area network 125 or if the wireless communication device user is not associated with a wireless communication device that is attempting to register to the land mobile radio network 121, then the network controller 101 determines if there is a wireless communication device that has capability to access the land mobile radio network 121, but that is not currently registered to the land mobile radio network 121 (block 521). When the wireless communication device has the capability and is registered to the local area network 125, the network controller 101 swaps registrations, via the respective networks, between the wireless communication device S-1 and the wireless communication device that has the capability to register (block 519). In particular, the network controller 101 sends a message to the land mobile network 121 to register the wireless communication device that has the capability to register, sends a message to the local area network 125 to de-register the same wireless communication device, and sends a message to the local area network 125 to register the wireless communication device S-1.

It should be noted that in the methods of FIGS. 4 and 5, each individual network may handle the operations of registering and de-registering directly based on approval and disapproval messages sent from the network controller 101. The networks and the network controller 101 exchange information regarding wireless communication device registrations, wireless communication devices, registration priorities, and user information to carry out the illustrated method. For example, the network may send a message to the network controller 101 informing the network controller 101 of the registration request of the wireless communication device S-1, whether the network has reached its registration capacity, and other information associated with the wireless communication device S-1. The information associated with the wireless communication device S-1 may include user identification and a registration priority of the wireless communication device S-1 for that particular network. The network controller 101 may respond to the network with a message approving registration and other wireless communication device information of the currently registered wireless communication devices (e.g., from table 301) and thereby enable the network to process registrations and de-registrations. It should also be noted that the steps of registering and de-registering are meant generally as providing network access and removing network access from the wireless communication device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of managing registration of a plurality of wireless communication devices with a communication system that includes a plurality of networks, at least one of the plurality of networks operating with a different communication protocol than another one of the plurality of networks, the method comprising:
assigning a registration limit to each of the plurality of networks, the registration limits indicating a maximum number of wireless communication devices supported by each of the plurality of networks;
assigning a registration priority to each of the plurality of wireless communication devices; and
controlling, via a controller, registration of each of the plurality of wireless communication devices to the plurality of networks based on
the registration limits,
the registration priorities, and
a quantity of wireless communication device registrations assigned to a wireless communication device user.

2. The method of claim 1, wherein controlling, via a controller, registration of each of the plurality of wireless communication devices to the plurality of networks further includes registering one of the plurality of wireless communication devices to one of the plurality of networks regardless of the registration priority assigned to the one of the plurality of wireless communication devices, when the registration limit of the one of the plurality of networks has not been reached.

3. The method of claim 1, wherein assigning a registration priority to each of the plurality of wireless communication devices further includes assigning multiple registration priorities for connection to the plurality of networks to at least some of the plurality of wireless communication devices, wherein each one of the multiple registration priorities is assigned to a different one of the plurality of networks.

4. The method of claim 1, further comprising:
de-registering one of the plurality of wireless communication devices from one of the plurality of networks when:
another one of the plurality of wireless communication devices is requesting registration to the one of the plurality of networks,
the one of the plurality of networks is at its registration limit, and
the registration priority of the one of the plurality of wireless communication devices is lower than the registration priority of the another one of the plurality of wireless communication devices; and
registering the another one of the plurality of wireless communication devices.

5. The method of claim 1, further comprising:
de-registering one of the plurality of wireless communication devices from one of the plurality of networks when:
another one of the plurality of wireless communication devices is requesting registration to the one of the plurality of networks,
the one of the plurality of networks is at its registration limit, and
the one of the plurality of wireless communication devices is registered with two or more networks of the plurality of networks; and
registering the another one of the plurality of wireless communication devices.

6. The method of claim 1, further comprising denying registration of one of the plurality of wireless communication devices from one of the plurality of networks, when the one of the plurality of wireless communication devices is registered on another one of the plurality of networks.

7. The method of claim 1, further comprising denying registration of one of the plurality of wireless communication devices from one of the plurality of networks, when the registration priority of the one of the plurality of wireless communication devices is lower than the registration priority of any other wireless communication devices of the plurality of wireless communication devices.

8. The method of claim 1, further comprising:
denying registration to one of the plurality of wireless communication devices from one of the plurality of networks when
the plurality of wireless communication devices are not registered with two or more networks of the plurality of networks, and
the plurality of wireless communication devices have a higher registration priority than the registration priority of the one of the plurality of wireless communication devices; and
connecting the one of the plurality of wireless communication devices via short range communication to another one of the plurality of wireless communication devices thereby providing access to the one of the plurality of networks through short range communication.

9. The method of claim 1, further comprising:
de-registering one of the plurality of wireless communication devices from one of the plurality of networks when
another one of the plurality of wireless communication devices is requesting registration to the one of the plurality of networks,
the one of the plurality of networks is at its registration limit,
the one of the plurality of wireless communication devices is requesting registration to another one of the plurality of networks,
the another one of the plurality of networks is at its registration limit, and
the another one of the plurality of wireless communication devices is registered on the another one of the plurality of networks;
de-register the another one of the plurality of wireless communication devices from the another one of the plurality of networks;
register the another one of the plurality of wireless communication devices to the one of the plurality of networks; and
register the one of the plurality of wireless communication devices to the another one of the plurality of networks.

10. The method of claim 1, further comprising:
de-registering one of the plurality of wireless communication devices from one of the plurality of networks when
another one of the plurality of wireless communication devices is requesting registration to the one of the plurality of networks,
the one of the plurality of networks is at its registration limit,
the one of the plurality of wireless communication device has capability to access another one of the plurality of networks, and
the another one of the plurality of networks has not reached its registration limit;
registering the one of the plurality of wireless communication devices on the another one of the plurality of networks; and
registering the another one of the plurality of wireless communication devices on the one of the plurality of networks.

11. A communication system for managing registration of a plurality of wireless communication devices, the communication system comprising:
a plurality of networks, at least one of the plurality of networks operating with a different communication protocol than another one of the plurality if networks;
a controller configured to
assign a registration limit to each of the plurality of networks, the registration limits indicating a maximum number of wireless communication devices supported by each of the plurality of networks;
assign a registration priority to each of the plurality of wireless communication devices;
control registration of each of the plurality of wireless communication devices to the plurality of networks based on
the registration limits,
the registration priorities, and
a quantity of wireless communication device registrations assigned to a wireless communication device user.

12. The system of claim 11, wherein the controller is further configured to register one of the plurality of wireless communication devices to one of the plurality of networks regardless of the registration priority assigned to the one of the plurality of wireless communication devices, when the registration limit of the one of the plurality of networks has not been reached.

13. The system of claim 11, wherein the controller is further configured to assign multiple registration priorities for connection to the plurality of networks to at least some of the plurality of wireless communication devices, wherein each one of the multiple registration priorities is assigned to a different one of the plurality of networks.

14. The system of claim 11, wherein the controller is further configured to
de-register one of the plurality of wireless communication devices from one of the plurality of networks
when another one of the plurality of wireless communication devices is requesting registration to the one of the plurality of networks,
the one of the plurality of networks is at its registration limit, and
the registration priority of the one of the plurality of wireless communication devices is lower than the registration priority of the another one of the plurality of wireless communication devices; and
register the another one of the plurality of wireless communication devices.

15. The system of claim 11, wherein the controller is further configured to
de-register one of the plurality of wireless communication devices from one of the plurality of networks
when another one of the plurality of wireless communication devices is requesting registration to the one of the plurality of networks,
the one of the plurality of networks is at its registration limit, and
the one of the plurality of wireless communication devices is registered with two or more networks of the plurality of networks; and
register the another one of the plurality of wireless communication devices.

16. The system of claim 11, wherein the controller is further configured to deny registration of one of the plurality of wireless communication devices from one of the plurality of networks, when the one of the plurality of wireless communication devices is registered on another one of the plurality of networks.

17. The system of claim 11, wherein the controller is further configured to deny registration of one of the plurality of wireless communication devices from one of the plurality of networks, when the registration priority of the one of the plurality of wireless communication devices is lower than the registration priority of any other wireless communication devices of the plurality of wireless communication devices.

18. The system of claim 11, wherein the controller is further configured to
deny registration to one of the plurality of wireless communication devices from one of the plurality of networks when
the plurality of wireless communication devices are not registered with two or more networks of the plurality of networks, and
the plurality of wireless communication devices have a higher registration priority than the registration priority of the one of the plurality of wireless communication devices; and
connect the one of the plurality of wireless communication devices via short range communication to another one of the plurality of wireless communication devices thereby providing access to the one of the plurality of networks through short range communication.

19. The system of claim 11, wherein the controller is further configured to
de-register one of the plurality of wireless communication devices from one of the plurality of networks when
another one of the plurality of wireless communication devices is requesting registration to the one of the plurality of networks,
the one of the plurality of networks is at its registration limit,
the one of the plurality of wireless communication devices is requesting registration to another one of the plurality of networks,
the another one of the plurality of networks is at its registration limit, and
the another one of the plurality of wireless communication devices is registered on the another one of the plurality of networks;
de-register the another one of the plurality of wireless communication devices from the another one of the plurality of networks;
register the another one of the plurality of wireless communication devices to the one of the plurality of networks; and
register the one of the plurality of wireless communication devices to the another one of the plurality of networks.

20. The system of claim 11, wherein the controller is further configured to
de-register one of the plurality of wireless communication devices from one of the plurality of networks when
another one of the plurality of wireless communication devices is requesting registration to the one of the plurality of networks,
the one of the plurality of networks is at its registration limit,
the one of the plurality of wireless communication device has capability to access another one of the plurality of networks, and
the another one of the plurality of networks has not reached its registration limit;
register the one of the plurality of wireless communication devices on the another one of the plurality of networks; and
register the another one of the plurality of wireless communication devices on the one of the plurality of networks.
